(19) United States
(12) Patent Application Publication
(10) Pub. No.: US 2007/0161523 A1
(43) Pub. Date: Jul. 12, 2007

(54) Lens care compositions

(76) Inventor: Fu-Pao Tsao, Lawrenceville, GA (US)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 11/599,977

(22) Filed: Nov. 15, 2006

Related U.S. Application Data
(60) Provisional application No. 60/737,148, filed on Nov. 16, 2005.

(51) Int. Cl. C11D 3/00

(52) U.S. Cl. 510/112

(57) ABSTRACT

The present invention provides a lens care composition having a persistent cleaning-efficacy characterized by substantially maintaining the light transmittance at around 280 nm of a contact lens after at least 15 cycles of soiling with a soiling solution containing proteins and subsequent cleaning with the lens care composition of the invention. The lens care composition comprises at least one surfactant, a polyvinylpyrrolidone (PVP), a cellulose ether, and xylitol, wherein in combination with polyvinylpyrrolidone (PVP), a cellulose ether, and xylitol, the surfactant provides the persistent cleaning-efficacy.

This application claims the benefit under 35 U.S.C. §119 (e) of U.S. provisional application Ser. No. 60/737,148 filed Nov. 16, 2005.

This invention relates generally to aqueous solutions useful for treating contact lenses. More specifically, the invention pertains to aqueous solutions that not only clean (or clean/disinfect) contact lenses but also preserve lens cleanness as substantially clean as new lenses even after a number of cycles of wearing and cleaning. Such solutions are particularly useful as a basis for formulating contact lens care products.

### BACKGROUND OF THE INVENTION

Contact lenses provide a means for vision correction for a wide range of consumers. The advantages of contact lens wear are numerous. Improved convenience and improved appearance in comparison to spectacle glasses are probably the two most important advantages to most consumers. However, contact lenses require stringent care regimes in order to ensure comfort and avoid ocular infections. Proper care of contact lenses typically requires the consumer to periodically clean, disinfect, and/or rinse the lenses. Cleaning usually refers to removal of lipids, proteins or other matter which has become affixed to a lens. Disinfecting usually refers to inactivating of harmful bacteria or fungi whenever the lenses are removed from the eye, which is usually on a daily basis. Rinsing usually refers to removing debris from the lens before placing the lens in the eye.

Traditionally, disinfecting, cleaning and rinsing of lenses are carried out at the end of day (e.g., in the evening) by, in no particular order, mechanically rubbing lenses and immersing them in an appropriate lens care solution (for example, a single- or multiple-purpose care solution) in a contact lens case. Such lens cases can be used to store contact lenses between use periods. When it is desired to treat contact lenses, the appropriate contact lens care composition is removed or dispensed from a bottle or container including the composition and passed into the contact lens case in which the contact lenses have been placed. Contact lenses are often left in the lens care solution in the lens case for an extended time, for example, overnight or at least several hours. After treatment, the contact lenses are ready for wear in the eyes of an user.

In recent years, multiple-purpose solutions, which clean, disinfect, and rinse contact lenses all without mechanically rubbing lenses, have been developed as a new type of lens care systems. These new systems start dominating the most of the lens care market. Such popularity is most likely derived from the easiness and convenience provided by these new systems to consumers. However, there is one big down side associated with these new systems. Without mechanically rubbing worn lenses, their cleanness would be hard to be maintained (or preserved) as clean as new lenses. Deposits (e.g., proteins and/or lipids, the likes) on contact lenses will decrease their light transmissibility (or transmittance) and thereby affect adversely visual acuity which the lenses can provide to an user.

It would be desirable to clean, disinfect, and rinse worn contact lenses without mechanically rubbing them while preserving (maintaining) their cleanness as substantially clean as new lenses. Therefore, there exist needs for a lens care solution capable of cleaning, disinfecting and rinsing contact lenses while preserving their cleanness as substantially clean as new lenses. It is to the provision of a lens care product meeting these and other needs that the present invention is primarily directed.

### SUMMARY OF THE INVENTION

Generally described, the present invention provides a lens care composition having a persistent cleaning-efficacy characterized by substantially maintaining the light transmittance at around 280 nm of a contact lens after at least 10 cycles of soiling with a soiling solution and subsequent cleaning with the lens care composition of the invention. The lens care composition comprises at least one surfactant, a polyvinylpyrrolidone (PVP), a cellulose ether, and xylitol, wherein in combination with polyvinylpyrrolidone (PVP), a cellulose ether, and xylitol, the surfactant provides the persistent cleaning-efficacy. The composition of the invention allows for the formulation of a multipurpose lens care solution for disinfecting, cleaning, and rinsing contact lens without rubbing lenses while preserving their cleanness as substantially clean as new lenses.

The present invention provides the foregoing and other features, and the advantages of the invention will become further apparent from the following detailed description of the example embodiments set forth herein, read in conjunction with the accompanying figures. The detailed description and figures are merely illustrative of the invention and do not limit the scope of the invention, which is defined by the appended claims and equivalents thereof.

### BRIEF DESCRIPTION OF THE DRAWINGS

FIG. 1 shows the transmittance of a contact lens as function of number of cycle of simulated wearing and cleaning with a lens care solution without rubbing.

### DETAILED DESCRIPTION OF EXAMPLE EMBODIMENTS

The present invention may be understood more readily by reference to the following detailed description of the invention taken in connection with the accompanying drawing figures, which form a part of this disclosure. Unless defined otherwise, all technical and scientific terms used herein have the same meaning as commonly understood by one of ordinary skill in the art to which this invention belongs. Generally, the nomenclature used herein is well known and commonly employed in the art. Conventional methods are used for carrying out the disclosed procedures, such as those provided in the art and various general references. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, reference to singular forms such as “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The invention relates to a lens care composition having a persistent cleaning-efficacy characterized by substantially maintaining the light transmittance at around 280 nm of a contact lens after at least 10 cycles of soiling and subsequent cleaning. The present invention is based upon the unexpected and beneficial finding that a formulation containing at least a surfactant, a polyvinylpyrrolidone (PVP), a cellulose ether, and xylitol can have a persistent cleaning-efficacy. When such formulation is used to clean contact lenses (verifilcon) soiled with a protein solution comprising 0.1% lysozyme, 0.4% albumin, 0.5% boric acid, 0.6% sodium chloride, 60 ppm Dequest 2060S, 0.03% sodium perborate, and water (pH˜7.0), it cleans effectively the soiled lenses. Even after 30 consecutive cycles of soiling and cleaning (with the formulation of the invention), the transmittance at around 280 nm of the cleaned lenses is substantially equal to those of new lenses. When Optifree® Express lens MPS disinfecting solution (from Alcon) is used to clean soiled lenses (vifilcon), the transmittance at around 280 nm of the cleaned lenses decreases as the number of cycle of soiling and cleaning increases.

A lens care composition of the invention can be used to clean contact lenses including hard (PMMA) contact lenses, soft (hydrophilic) contact lenses, and rigid gas permeable (RGP) contact lenses. The soft contact lenses are hydrogel contact lens or silicone hydrogel contact lenses.

A “hydrogel” refers to a polymeric material which can absorb at least 10 percent by weight of water when it is fully hydrated. Generally, a hydrogel material is obtained by polymerization or copolymerization of at least one hydrophilic monomer in the presence of or in the absence of additional monomers and/or macromers.

A “silicone hydrogel” refers to a hydrogel obtained by copolymerization of a polymerizable composition comprising at least one silicone-containing vinylic monomer or at least one silicone-containing macromer.

“Hydrophilic,” as used herein, describes a material or portion thereof that will more readily associate with water than with lipids.

The term “cleaning” means that the solution contains one or more active ingredients in sufficient concentrations to loosen and remove loosely held lens deposits and other contaminants on the surface of the article to be cleaned. While not necessary with the present invention, a user may wish to use the solutions of the present invention in conjunction with digital manipulation (for example, manual rubbing of the lens with a solution) or with an accessory device that agitates the solution in contact with the lens, for example, a mechanical cleaning aid.

In accordance with the invention, a lens care composition is ophthalmic safe. The term “ophthalmically safe” with respect to a lens care solution is meant that a contact lens treated with the solution is safe for direct placement on the eye without rinsing, that is, the solution is safe and sufficiently comfortable for daily contact with the eye via a contact lens. An ophthalmically safe solution has a tonicity and pH that is compatible with the eye and comprises materials, and amounts thereof, that are non-cytotoxic according to international ISO standards and U.S. FDA regulations.

The term “compatible with the eye” means a solution that may be in intimate contact with the eye for an extended period of time without significantly damaging the eye and without significant user discomfort.

In one aspect, the invention provides a lens care composition having a persistent cleaning-efficacy characterized by substantially maintaining the light transmittance at around 280 nm of a vifilcon contact lens after at least 10 cycles of soiling with a soiling solution and subsequent cleaning with the lens care composition under no-rubbing conditions and comprising at least one surfactant, a polyvinylpyrrolidone (PVP), a cellulose ether, and xylitol, wherein in combination with polyvinylpyrrolidone (PVP), a cellulose ether, and xylitol, the surfactant provides the persistent cleaning-efficacy, wherein the soiling solution is an aqueous solution having a pH of about 7.0 and containing 0.1% lysozyme, 0.4% albumin, 0.5% boric acid, 0.6% sodium chloride, 60 ppm Dequest® 2060S (diethylene triamine penta(methylene phosphonic acid), and 0.03% sodium perborate.

The term “substantially maintaining the light transmittance at around 280 nm of a contact lens after at least 15 cycles of soiling and cleaning under no-rubbing conditions” is intended to describe that the light transmittance at around 280 nm of the cleaned contact lens after at least 15 cycles of soiling and cleaning without rubbing lens is substantially unchanged (i.e., less than about 20%, preferably less than about 10% of decrease in transmittance at around 280 nm) relative to a new (unworn) lens.

Transmittance (%) at around 280 nm is the wavelength of the chosen proteins and transmittance (%) through the lens indicates cleanness of a lens. The lower the transmittance (%), the dirtier the lens, the higher the transmittance (%), the lens is cleaner and closer to the visual acuity of a new lens. In accordance with the invention, the transmittance at around 280 nm is determined by using UV-visible spectrophotometer and obtained by averaging results of at least 5 lenses (independent experiment with each lens).

Any suitable known surfactants can be used in the invention. Examples of suitable surfactants include, but are not limited to poloxamers under the tradename Pluronic from BASF Corp. (Pluronic™ and Pluronic-R™) which are nonionic surfactants consisting of block copolymers of propylene oxide and ethylene oxide; poloxamine which is a block copolymer derivative of ethylene oxide and propylene oxide combined with ethylene diamine; tyloxapol, which is 4-(1,1,3,3-tetramethylbutyl)phenol polymer with formaldehyde and oxirane; ethoxylated alkyl phenols, such as various surface active agents available under the tradenames TRITON (Union Carbide, Tarrytown, N.Y., USA) and IGEPAL (Rhone-Poulenc, Cranbury, N.J., USA); polysorbates such as polysorbate 20, including the polysorbate surface active agents available under the tradename TWEEN (ICI Americas, Inc., Wilmington, Del., USA.); alkyl glucosides and polyglucosides such as products available under the tradename PLANTAREN (Henkel Corp., Hoboken, N.J., USA); and polyethoxylated castor oils commercially available from BASF under the trademark CREMAPHOR.

Preferred surfactants include homopolymers of polyethylene glycol or polyethyleneoxide, and certain poloxamers such as materials commercially available from BASF under the tradenames PLURONIC® 17R4, PLURONIC® F-68NF, PLURONIC® F68LF, and PLURONIC® F127, with PLURONIC® F-68NF (National Formulary grade) being the most preferred. When present, poloxamers may be employed at from about 0.001% to about 5% by weight, preferably from about 0.005% to about 1% by weight, more preferably from about 0.05% to about 0.6% by weight.

In accordance with the invention, a cellulose ether is preferably methyl cellulose (MC), ethyl cellulose, hydroxymethylcellulose, hydroxyethyl cellulose (HEC), hydroxypropylcellulose, hydroxypropylmethyl cellulose (HPMC), or a mixture thereof. More preferably, a cellulose ether is hydroxyethyl cellulose (HEC), hydroxypropylmethyl cellulose (HPMC), or a mixture thereof. The cellulose ether is present in the composition in an amount of from about.0.01% to about 5% by weight, preferably from about 0.05% to about 3% by weight, even more preferably from about 0.1% to about 1% by weight, based on the total amount of contact lens care composition. It is believed that a cellulose ether can be used to increase the viscosity of a lens care and also can serve as a lubricant in the lens care composition.

The polyvinylpyrrolidone (PVP) used in the compositions of the invention is a linear homopolymer or essentially a linear homopolymer comprising at least 90% repeat units derived from 1-vinyl-2-pyrrolidone monomers, the polymer more preferably comprising at least about 95% or essentially all of such repeat units, the remainder selected from polymerization-compatible monomers, preferably neutral monomers, such as alkenes or acrylates. Other synonyms for PVP include povidone, polyvidone, 1-vinyl-2-pyrolidinone, and 1-ethenyl-2-pyrolionone (CAS registry number 9003-39-8). The PVP used in the present invention suitably has a weight average molecular weight of about 10,000 to 250,000, preferably 30,000 to 100,000. Such materials are sold by various companies, including ISP Technologies, Inc. under the trademark PLASDONE™ K-29/32, from BASF under the trademark KOLLIDON™ for USP grade PVP, for example KOLLIDON™ K-30 or K-90. While the invention is not limited to any specific PVP, K-90 PVP is preferred, more preferably pharmaceutical grade.

In accordance with the invention, polyvinylpyrrolidone can function as a lubricant and provide comfort to an eye. Polyvinylpyrrolidone can be present up to 2% by weight, preferably from about 0.1% to about 1.0% by weight, more preferably from about 0.2% to about 0.5% by weight.

Xylitol is a five-carbon sugar alcohol that is found naturally in many plants and fruits. It has been used as a sweetener in food products such as chewing gum because it is noncaloric and has a sweetness quality equal to that of sugar. Xylitol can be used as a tonicity agent to adjust the tonicity (osmolality) of a lens care composition. Xylitol is used in a preferred contact lens care composition of the invention in an amount of from about 0.4% to about 10% by weight, more preferably in an amount of from about 1.0% to about 8% by weight, most preferably in an amount of from 2% to about 6% by weight, based on the total amount of contact lens care composition which is advantageously formulated in aqueous solution.

It has now surprisingly been found that the combination PVP, a cellulose ether and xylitol with at least one surfactant can possesses an enhanced cleaning efficacy. This guards against the appearance of dryness, which can lead to a reduced lachrymal film. The usage of the above-described active ingredient combination can also substantially improves comfort when wearing contact lenses. Negative effects caused by surface-active substances and preservatives are reduced and the contact lenses are prevented from drying out.

In a preferred embodiment, the lens care solution is a multipurpose solution capable of disinfecting, cleaning, and rinsing a contact lens.

The term “disinfecting solution” means a solution containing one or more microbiocidal compounds, that is effective for reducing or substantially eliminating the presence of an array of microorganisms present on a contact lens, which can be tested by challenging a solution or a contact lens after immersion in the solution with specified inoculums of such microorganisms. The term “disinfecting solution” as used herein does not exclude the possibility that the solution may also be useful for a preserving solution or that the disinfecting solution may additionally be useful for daily cleaning, rinsing, and storage of contact lenses.

A solution that is useful for cleaning, chemical disinfection, storing, and rinsing an article, such as a contact lens, is referred to herein as a “multi-purpose solution.” Such solutions may be part of a “multi-purpose solution system” or “multi-purpose solution package.” The procedure for using a multi-purpose solution, system or package is referred to as a “multi-functional disinfection regimen.” Multi-purpose solutions do not exclude the possibility that some wearers, for example, wearers particularly sensitive to chemical disinfectants or other chemical agents, may prefer to rinse or wet a contact lens with a another solution, for example, a sterile saline solution prior to insertion of the lens. The term “multi-purpose solution” also does not exclude the possibility of periodic cleaners not used on a daily basis or supplemental cleaners for removing proteins, for example enzyme cleaners, which are typically used on a weekly basis.

A disinfecting solution of the invention can be used to disinfect contact lenses against a wide range of microorganisms including but not limited to Fusarium solani, Staphylococcus aureus, Pseudomonas aeruginosa, Serratia marcescens and Candida albicans. For the purposes of the present invention the term “disinfect” means the rendering non-viable of substantially all pathogenic microbes that are in the vegetative state, including gram negative and gram positive bacteria, as well as fungi. The chemical compounds and compositions that render such pathogenic microbes inactive are known as microbicides.

A disinfecting or MPS solution of the invention must contain a microbicide in a concentration sufficient to effect the desired disinfection of a contact lens. The specific concentrations required for the microbicides useful in this invention must be determined empirically for each microbicide. Some of the factors affecting the effective concentration are specific activity of the microbicide against the specified pathogens, the molecular weight of the microbicide, and the solubility of the microbicide. It is also important that the chosen microbicides be employed in a physiologically tolerable concentration. The list of microbicides which may be employed in the present invention include, but is not in limited to biguanides, biguanide polymers, salts thereof, N-alkyl-2-pyrrolidone, polyquaternium-1, bronopol, benzalkonium chloride, and hydrogen peroxide. The presently useful antimicrobial biguanides include biguanides, biguanide polymers, salts thereof, and mixtures thereof. Preferably, the biguanide is selected from alexidine free-base, salts of alexidine, chlorhexidine free-base, salts of chlorhexidine, hexetidine, hexamethylene biguanides, and their polymers, and salts thereof. Most preferably, the biguanide is a hexamethylene biguanide polymer (PHMB), also referred to as polyaminopropyl biguanide (PAPB).

Typical solutions of this invention contain the microbicides PHMB in an amount of from about 0.01 to about 10 ppm, preferably from about 0.05 to about 5 ppm, more preferably from about 0.1 to about 2 ppm, even more preferably from about 0.2 to about 1.5 pp.

Although PHMB has a broad spectrum of activity and non-specific mode of action against bacteria, PHMB might be able to cause some level of corneal staining (Jones Lyndon, et. al. “Asymptomatic corneal staining associated with the use of balafilcon silicon-hydrogel contact lenses disinfected with a polyaminopropyl biguanide—preserved care regimen”, Optometry and Vision Science 79: 753-61(2002)). Therefore, it would be desirable to lower the amount of PHMB in a lens care solution while maintaining the antimicrobial efficacy of the lens care solution. It has been shown in studies that the addition of PVP, a cellulose ether and xylitol does not have negative effects on the antimicrobial efficacy of a disinfecting solutions but could increase the microbiological efficacy of PHMB present in the contact lens care compositions according to the invention without resulting in negative effects as regards toxicity. The concentration of PHMB can be reduced to about 0.5 ppm.

Where a lens care composition comprises a biguanide or a biguanide polymer (PHMB) as a microbiocide, it comprises preferably less than 1000 ppm, more preferably less than 500 ppm, even more preferably less than 100 ppm chloride ions. A 0.6% sodium chloride solution, which is probably close to the concentration of sodium chloride in eye, would result in almost 3600 ppm chloride ions in the solution. Such a high concentration of chloride ion would diminish the antimicrobial effectiveness of PHMB, especially those having less than 0.5 ppm PHMB.

Apart from the above-described ingredients, a contact lens care composition of the invention generally contain one or more other constituents, e.g. buffer substances, occularly acceptable tonicity agents (substances that affect the tonicity) other than xylitol, complexing (chelating) agents and/or dexpathenol. Although it is generally unnecessary, an enzymatic cleaning substance may also be present in the contact lens care products according to the invention. The amounts of these or other conventional additives used in the contact lens care compositions according to the invention are variable within the limits known to the person skilled in the art.

The contact lens care products typically are formulated in such a way that they are isotonic with the lachrymal fluid. A solution which is isotonic with the lachrymal fluid is generally understood to be a solution whose concentration corresponds to the concentration of a 0.9% sodium chloride solution. Deviations from this concentration are possible throughout, provided that the contact lenses to be treated are not damaged.

The isotonicity with the lachrymal fluid, or even another desired tonicity, may be adjusted by adding xylitol and optionally organic or inorganic substances which affect the tonicity. Suitable occularly acceptable tonicity agents include, but are not limited to sodium chloride, potassium chloride, glycerol, mannitols, sorbitol, and mixtures thereof. The tonicity of the solution is typically adjusted to be in the range from about 200 to about 450 milliosmol (mOsm), preferably from about 250 to 350 mOsm.

One especially suitable chelating agent is ethylenediamine tetraacetic acid, abbreviated to EDTA, or salts thereof such as sodium salts. EDTA is low level non-irritating chelating agent and can be synergistic with PHMB to increase antimicrobial efficacy. Typical amounts of these substances are from about 0.001% to about 1% by weight, based on the total amount of contact lens care composition.

The composition of the present invention preferably contains a buffer. The buffer maintains the pH preferably in the desired range, for example, in a physiologically acceptable range of about 6.5 to about 7.5. Any known, physiologically compatible buffer systems can be used. Suitable buffer substances as a constituent of the contact lens care composition according to the invention are known to the person skilled in the art. Examples are boric acid, borates, e.g. sodium borate, citric acid, citrates, e.g. potassium citrate, bicarbonates, e.g. sodium bicarbonate, TRIS (trometamol, 2-amino-2-hydroxymethyl-1,3-propanediol), bis-TRIS-propane, phosphate buffers, e.g. Na₂HPO₄, NaH₂PO₄, and KH₂PO₄ or mixtures thereof. The amount of each buffer agent is that amount necessary to be effective in achieving a pH of the composition of from about 6.5 to about 7.5. Typically, it is present in an amount of from 0.001% to 2%, preferably from 0.01% to 1%; most preferably from about 0.05% to about 0.30%.

The solutions of the present invention preferably contain dexpanthenol. Dexpanthenol is an alcohol of pantothenic acid, also called Provitamin B5, D-pantothenyl alcohol or D-panthenol. Dexpanthenol may be used in the solutions according to the invention in an amount of 0.005% to 10%, especially in an amount of 0.01 to 5%, preferably in an amount of 0.01 to 1%, more preferably in an amount of 0.01 to 0.5%, most preferably from about 0.01 to 0.25%.

The contact lens care compositions according to the invention are produced in known manner, in particular by means of conventional mixing of the constituents with water or dissolving the constituents in water.

Aqueous solutions comprising the following components have been found to be particularly useful in cleaning and disinfecting contact lenses:
poloxamer 0.005% to 1%
PVP 0.01% to 1%
HPMC 0.05% to 3%
Xylitol 1% to 8%
PHMB less than 1.5 ppm
dexpanthenol 0.005% to 0.2%
tyloxapol less than 0.5%
Na₂HPO₄ less than 0.2%
EDTA less than 0.1%
Chloride ions less than 1000 ppm

Even more preferred are those solutions having the following components:
poloxamer 0.05% to 0.6%
PVP 0.05% to 0.5%
HPMC 0.1% to 1%
Xylitol 2% to 6%
PHMB less than 0.8 ppm
dexpanthenol 0.01% to 0.1%
tyloxapol 0% to 0.1%
Na₂HPO₄ 0.001% to 0.02%
EDTA 0.001% to 0.006%
Chloride ions less than 500 ppm

The contact lens care compositions according to the invention are suitable for all kinds of contact lenses. This includes in particular the so-called hard and soft contact lenses, and also the so-called hard-flexible or highly gas-permeable contact lenses. The contact lens care compositions according to the invention have cleaning action and, in addition, optionally have antimicrobial action.

The compositions according to the invention are especially suitable for cleaning and, where appropriate, for disinfecting contact lenses. The contact lens care compositions according to the invention are used in known manner, e.g. by bringing the contact lens into contact with the contact lens care composition for a period of time that is sufficient to clean or disinfect it. Depending on the lens type and the degree of soiling, a sufficient time span ranges from a few minutes to about 24 hours, preferably from about 1 to about 12 hours, more preferably from about 2 to about 8 hours, even more preferably from about 4 to about 12 hours, has proved to be practicable.

The contacting temperature is in the range preferred from about 0° C. to about 100° C., more preferably from-about 10° C. to about 60° C., still more preferably from about 15° C. to about 37° C. Contacting at or about ambient temperature is very convenient and useful. The contacting preferably occurs at or about atmospheric pressure.

Where a lens care solution is a multipurpose solution, the contacting preferably occurs for a time in the range of from about 5 minutes or about 1 hour to about 12 hours or more. Especially preferred are those solutions have 0.5 ppm or less PHMB and can obtain at least a 1 log reduction in C. albicans within 15 minutes of contact with the lens. Also preferred are those having less than 0.25 ppm PHMB and obtaining at least 1.0, more preferably 1.5 log, reduction in C. albicans within 15 minutes, more preferably at least a 2.0 log reduction in C. albicans within 30 minutes.

The contact lens can be contacted with the solution by immersing the lens in the solution. Although not necessary, the solution containing the contact lens can be agitated, for example, by shaking the container containing the solution and contact lens, to at least facilitate removal of deposit material from the lens.

In another aspect, the invention provides a method for cleaning and/or disinfecting contact lenses. The method comprises the step of bringing one or more contact lenses into contact with the contact lens care composition of the invention for a period of time that is sufficient to clean and/or disinfect the one or more contact lenses.

The solutions and methods of the present invention may be used in conjunction with enzymes to remove debris or deposit material from the contact lens as the solutions of the present invention have no negative effect on the proteolytic activity of enzymes, such as UNIZYME®. After such contacting step, the contact lens optionally may be manually rubbed with saline, or even rinsed without rubbing, to remove further deposit material from the lens. The cleaning method can also include rinsing the lens substantially free of the liquid aqueous medium prior to returning the lens to a wearer's eye.

In a further aspect, the present invention provides a kit for cleaning and/or disinfecting contact lenses. The kit comprises a bottle containing a lens care solution, wherein the lens care solution can be dispensed from the bottle into a container where the lens care solution is in contact with one or more contact lenses for a period of time sufficient long to clean and/or disinfect them. The lens care solution has a persistent cleaning-efficacy characterized by substantially maintaining the light transmittance at around 280 nm of a vifilcon contact lens after at least 15 cycles of soiling with a soiling solution and subsequent cleaning with the lens care composition under no-rubbing conditions, wherein the soiling solution is an aqueous solution having a pH of about 7.0 and containing 0.1% lysozyme, 0.4% albumin, 0.5% boric acid, 0.6% sodium chloride, 60 ppm Dequest® 2060S (diethylene triamine penta(methylene phosphonic acid), and 0.03% sodium perborate. The lens care solution also comprises at least one surfactant, a polyvinylpyrrolidone (PVP), a cellulose ether, and xylitol, wherein in combination with polyvinylpyrrolidone (PVP), a cellulose ether, and xylitol, the surfactant provides the persistent cleaning-efficacy.

The kit can optionally include one or more lens care cases for treating contact lenses and/or instructions for how to use the lens care solution to clean and/or disinfect contact lenses.

The previous disclosure will enable one having ordinary skill in the art to practice the invention. In order to better enable the reader to understand specific embodiments and the advantages thereof, reference to the following examples is suggested.

### EXAMPLE 1

A solution according to the present invention is prepared by blending the following components: 0.1% PLURONIC® F-87; 0.2% PVP (KOLLIDON® K-90); 0.2% HPMC; 4% Xylitol; 0.5 ppm PHMB; 0.02% dexpanthenol; 0.02% tyloxapol; 0.01% Na₂HPO₄ (anhydrous); and 0.001% to 0.02% EDTA. The pH of the solution is adjusted with phosphoric acid to about 7.0.

### EXAMPLE 2

The cleaning efficacy of the solution prepared in Example 1 is studied in comparison with Alcon's Optifree® Express by no rub regime. Vifilcon lenses (Focus lenses) are used. Vifilcon material is an ionic hydrogel material which contains about 55% water in equilibrium.

Alcon's Optifree® Express MPS disinfecting solution contains citrate, Tetronic 1304 (tetra-functional block copolymers based on ethylene oxide and propylene oxide), AMP-95 (Aminomethyl Propanol), sodium chloride, boric acid, sorbitol, AMP-95, edetate Disodium, 0.001% Polyquad®** (polyquaternium-1), and 0.0005% Aldox®** (myristamidopropyl dimethylamine).

Cleaning efficacy is determined as follows. The lenses are first immersed in a soiling solution for about 10 hours to simulate lens usage in eye. The soiling solution is an aqueous solution having a pH of about 7.0 and containing 0.1% lysozyme, 0.4% albumin, 0.5% boric acid, 0.6% sodium chloride, 60 ppm Dequest® 2060S (diethylene triamine penta(methylene phosphonic acid), and 0.03% sodium perborate. After being soiled, the lenses are immersed in a solution prepared in Example 1 for overnight (about 14 hours). One cycle is composed of one soiling and one cleaning. The above soiling and cleaning are repeated for 30 days. In each cycle, the transmittance at around 280 nm of each of 5 lenses is determined after soiling but before cleaning and then again after cleaning. The lenses that allowed more light transmittance (%) are considered the cleaner lenses throughout the study.

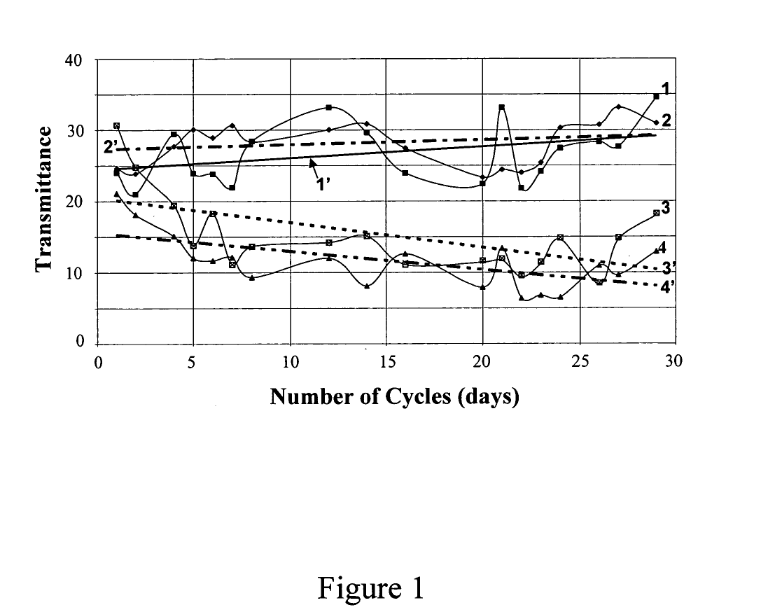

The results are shown in FIG. 1. Line 1 connects all data points obtained after cleaning with the solution of the invention; line 2 connects all data points obtained before cleaning with the solution of the invention but after soiling; line 3 connects all data points obtained after cleaning with Optifree® Express MPS disinfecting solution; line 4 connects all data points obtained before cleaning with Optifree® Express MPS disinfecting solution but after soiling. Linear fits of each series of data are shown as 1′, 2′, 3′, and 4′ respectively. The results indicate that a lens care solution of the invention has a persistent cleaning-efficacy better than Alcon's Optifree® Express MPS disinfecting solution. The solution of the invention can maintain the lenses at higher transmittance (cleaner) than Optifree® Express MPS disinfecting solution does after 15 cycles of soiling (simulated lens usage) and cleaning. When using the solution of the invention to clean lenses, the transmittance at 280 of the lenses remain substantially constant. In contrast, when using Alcon's Optifree® Express MPS disinfecting solution to clean lenses, the transmittance at 280 of the lenses decreases gradually as the number of cycles of soiling (simulated lens usage) and cleaning increases.

### EXAMPLE 3

A series of tests are conducted to evaluate the compatibility of the solution prepared in Example 1 with CIBASOFT® (tefilcon lens material containing 37.5% water, from CIBA Vision), FOCUS® 1-2 WEEK LENSES® (vifilcon material containing 55% water, from CIBA Vision) and FOCUS® NIGHT & DAY® (lotrafilcon A silicone hydrogel material containing 24% water, from CIBA Vision). It is found that, after 30 treatments of those lenses with the solution, there is no significant difference in lens parameters such as, for example, diameter, base curve, and center thickness. The solution is compatible with the tested lenses.

### EXAMPLE 4

A series of tests are conducted to evaluate the disinfecting performance of solutions prepared in accordance with Example 1 against Fusarium solani (F. solani), Candida albicans (C. albicans), Serratia marcescens (S. marcescens), Staphylococcus aureus (S. aureus), and Pseudomonas aeruginosa (P. aeruginosa). Two batches of the solution are used to run the tests in parallel and the results are averaged. For each organism, at least two inoculums are used and the obtained results are averaged as shown in Table 1.

TABLE 1

Observed log drops in organism after
a period of time

| | 1 hour | 4 hours | 6 hours | 24 hours |
|---|---|---|---|---|
| F. solani¹ | 1.3 | 2.3 | 2.5 | 3.0 |
| F. solani*² | 0.2 | 0.2 | 0.3 | 0.3 |
| C. albicans³ | 3.1 | 3.7 | 4.0 | 5.1 |
| S. marcescens⁴ | 3.0 | 5.3 | 5.2 | |
| S. aureus⁵ | 4.3 | 5.3 | 5.3 | |
| P. aeruginosa⁶ | 3.8 | 4.8 | 4.9 | |

*F. solani in organic soil.
¹Inoculum 1 = 4.2 × 10⁵ and Inoculum 2 = 1.3 × 10⁵;
²Inoculum 1 = 3.6 × 10⁵ and Inoculum 2 = 1.9 × 10⁵;
³Inoculum 1 = 4.9 × 10⁵ and Inoculum 2 = 2.8 × 10⁵;
⁴Inoculum 1 = 8.3 × 10⁵, Inoculum 2 = 4.2 × 10⁵, Inoculum 3 = 7.2 × 10⁵;
⁵Inoculum 1 = 9.6 × 10⁵ and Inoculum 2 = 5.5 × 10⁵;
⁶Inoculum 1 = 3.6 × 10⁵ and Inoculum 2 = 1.83 × 10⁵;

These results show the effectiveness of a MPS solution of the invention with a relatively low PHMB concentration of 0.5 ppm.

### EXAMPLE 5

A solution having identical composition shown in Example 1 except containing 0.6% sodium chloride is prepared. The concentration of sodium chloride simulates that in a tear. This solution is tested against C. albicans. Within 15 minutes, there is no kill at all of C. albicans. This probably means that when this solution contacts with tear in the eye, its anti-microbial efficacy would be diminished. This result is consistent with the greatly-reduced antimicrobial activity against F. solani in organic soil (Table 1 in Example 2). When the solution contacts with tear, the proteins and sodium chloride will inhibit the antimicrobial activity of PHMB. It believed that reduction in antimicrobial activity could lower effective concentration of an antimicrobial agent and therefore reduce the cytotoxic effect of the solution. It could lead to more comfort, more biocompatible.

The present compositions provide a very beneficial and advantageous combination of performance efficacy and lens wearer/user comfort and acceptability. In the context of contact lens care solutions, lens wearer/user comfort and acceptability are very important, for example, to promote regular and effective treating of contact lenses. Such treating of contact lenses ultimately promotes ocular health and reduces the frequency of problems caused by wearing contact lenses. Thus, lens wearer/user comfort and acceptability are of substantial importance and benefit in a contact lens care product, in particular in the present compositions which exhibit substantial, even enhanced, lens wearer/user comfort and acceptability.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part. Furthermore, titles, headings, or the like are provided to enhance the reader's comprehension of this document, and should not be read as limiting the scope of the present invention. Accordingly, the spirit and scope of the appended claims should not be limited to the description of the preferred versions contained therein.

What is claimed is:

1. An aqueous contact lens care solution,
having a persistent cleaning-efficacy characterized by substantially maintaining the light transmittance at around 280 nm of a vifilcon contact lens after at least 15 cycles of soiling with a soiling solution and subsequent cleaning with the lens care composition under no-rubbing conditions, wherein the soiling solution is an aqueous solution having a pH of about 7.0 and containing 0.1% lysozyme, 0.4% albumin, 0.5% boric acid, 0.6% sodium chloride, 60 ppm Dequest® 2060S (diethylene triamine penta(methylene phosphonic acid), and 0.03% sodium perborate; and
the contact lens care solution comprising at least one surfactant, a polyvinylpyrrolidone (PVP), a cellulose ether, and xylitol, wherein in combination with polyvinylpyrrolidone (PVP), a cellulose ether, and xylitol, the surfactant provides the persistent cleaning-efficacy.

2. The aqueous contact lens care solution of claim 1, wherein the light transmittance at around 280 nm of the cleaned contact lens after at least 15 cycles of soiling and cleaning without rubbing lens is substantially unchanged or decreased by about 20% or less relative to a new (unworn) lens.

3. The aqueous contact lens care solution of claim 1, wherein the at least one surfactant is a nonionic surfactant consisting of block copolymers of propylene oxide and ethylene oxide, wherein the polyvinylpyrrolidone is a linear or essentially linear homopolymer comprising at least 90% repeat units derived from 1-vinyl-2-pyrrolidone monomers, wherein the cellulose ether is selected from the group consisting of methyl cellulose (MC), ethyl cellulose, hydroxymethylcellulose, hydroxyethyl cellulose (HEC), hydroxypropylcellulose, hydroxypropylmethyl cellulose (HPMC), and a mixture thereof.

4. The aqueous contact lens care solution of claim 3, wherein the at least one surfactant is present in an amount of from about 0.005% to about 1% by weight.

5. The aqueous contact lens care solution of claim 3, wherein the cellulose ether is present in an amount of from about 0.01% to about 5% by weight.

6. The aqueous contact lens care solution of claim 6, wherein the cellulose ether is hydroxymethylcellulose, hydroxyethyl cellulose (HEC), hydroxypropylcellulose, hydroxypropylmethyl cellulose (HPMC) or a mixture thereof.

7. The aqueous contact lens care solution of claim 3, wherein the polyvinylpyrrolidone is present in an amount of from about 0.1% to about 1.0% by weight.

8. The aqueous contact lens care solution of claim 3, wherein the xylitol is present in an amount of from about 1.0% to about 8% by weight.

9. The aqueous contact lens care solution of claim 3, wherein the xylitol is present In an amount of from about 2% to about 6% by weight, wherein the polyvinylpyrrolidone is present in an amount of from about 0.2% to about 0.5% by weight, wherein the cellulose ether is present in an amount of from about 0.1% to about 1% by weight, and wherein the at least one surfactant is present in an amount of from about wherein the at least one surfactant is present in an amount of from about 0.05% to about 0.6% by weight by weight.

10. The aqueous contact lens care solution of claim 3, further comprising a polymeric antimicrobial agent.

11. The aqueous contact lens care solution of claim 10, wherein the polymeric antimicrobial agent is PHMB.

12. The aqueous contact lens care solution of claim 11, wherein the concentration of said PHMB is from about 0.05 to about 5 ppm.

13. The aqueous contact lens care solution of claim 11, wherein the concentration of said PHMB is from about 0.1 to about 2 ppm.

14. The aqueous contact lens care solution of claim 13, wherein the concentration of said PHMB is less than 1.5 ppm, where the aqueous contact lens care solution comprises less than 1000 ppm chloride ions.

15. The aqueous contact lens care solution of claim 14, wherein said solution contains both tyloxapol and a poloxamer.

16. The aqueous contact lens care solution of claim 14, further comprising dexpanthenol.

17. The aqueous contact lens care solution of claim 14, further comprising a chelating agent.

18. The aqueous contact lens care solution-of claim 17, wherein said chelating agent is EDTA.

19. A multipurpose contact lens solution which is an aqueous solution, comprising:
(a) from about 0.005% to about 1% by weight of at least one non-ionic surfactant;
(b) from about 0.01% to about 1% by weight of a polypyrrolidone;
(c) from about 0 05% to 3% of a cellulose ether;
(d) from about 1% to about 8% of xylitol
(e) less than 1.5 ppm PHMB
(f) 0.005% to 0.2% dexpanthenol
(g) less than 0.2% by weight of buffer substances;
(h) less than 0. 1% by weight of a chelating agent; and
(i) less than 1000 ppm chloride ions,
wherein said solution has a tonicity of 200 to 450 mOsm/kg and a pH of between 6 and 8.

20. The multipurpose contact lens solution of claim 19, wherein said solution has a persistent cleaning-efficacy characterized by substantially maintaining the light transmittance at around 280 nm of a vifilcon contact lens after at least 15 cycles of soiling with a soiling solution and subsequent cleaning with the lens care composition under no-rubbing conditions, wherein the soiling solution is an aqueous solution having a pH of about 7.0 and containing 0.1% lysozyme, 0.4% albumin, 0.5% boric acid, 0.6% sodium chloride, 60 ppm Dequest® 2060S (diethylene triamine penta(methylene phosphonic acid), and 0.03% sodium perborate.

21. The multipurpose contact lens solution of claim 20, wherein the at least one surfactant is a nonionic surfactant consisting of block copolymers of propylene oxide and ethylene oxide, wherein the polyvinylpyrrolidone is a linear or essentially linear homopolymer comprising at least 90% repeat units derived from 1-vinyl-2-pyrrolidone monomers, wherein the cellulose ether is selected from the group consisting of methyl cellulose (MC), ethyl cellulose, hydroxymethylcellulose, hydroxyethyl cellulose (HEC), hydroxypropylcellulose, hydroxypropylmethyl cellulose (HPMC), and a mixture thereof.

22. The multipurpose contact lens solution of claim 21, wherein the light transmittance at around 280 nm of the cleaned contact lens after at least 15 cycles of soiling and cleaning without rubbing lens is substantially unchanged or decreased by about 20% or less relative to a new (unworn) lens.

22. The multipurpose contact lens solution of claim 21, wherein the cellulose ether is hydroxymethylcellulose, hydroxyethyl cellulose (HEC), hydroxypropylcellulose, hydroxypropylmethyl cellulose (HPMC), or a mixture thereof.

23. A multipurpose contact lens solution which is an aqueous solution, comprising:
(a) from about 0.05% to about 0.6% by weight of a non-ionic surfactant or a mixture of non-ionic surfactants;
(b) from about 0.05% to about 0.5% by weight of polypyrrolidone;
(c) from about 0.1% to about 1% by weight of a cellulose ether;
(d) from about 2% to about 6% by weight of Xylitol
(e) less than 0.8 ppm PHMB
(f) from about 0.01% to 0.1% by weight of dexpanthenol
(g) from about 0.001% to about 0.02% by weight of buffer substances;
(h) from about 0.001% to about 0.006% by weight of a chelating agent; and
(i) less than 500 ppm chloride ions,
wherein said solution has a tonicity of 200 to 450 mOsmlkg and a pH of between 6 and 8.

24. The multipurpose contact lens solution of claim 21, wherein said solution has a persistent cleaning-efficacy characterized by substantially maintaining the light transmittance at around 280 nm of a vifilcon contact lens after at least 15 cycles of soiling with a soiling solution and subsequent cleaning with the lens care composition under no-rubbing conditions, wherein the soiling solution is an aqueous solution having a pH of about 7.0 and containing 0.1% lysozyme, 0.4% albumin, 0.5% boric acid, 0.6% sodium chloride, 60 ppm DequestI 2060S (diethylene triamine penta(methylene phosphonic acid), and 0.03% sodium perborate.

25. The multipurpose contact lens solution of claim 24, wherein the at least one surfactant is a nonionic surfactant consisting of block copolymers of propylene oxide and ethylene oxide, wherein the polyvinylpyrrolidone is a linear or essentially linear homopolymer comprising at least 90% repeat units derived from 1-vinyl-2-pyrrolidone monomers, wherein the cellulose ether is selected from the group consisting of methyl cellulose (MC), ethyl cellulose, hydroxymethylcellulose, hydroxyethyl cellulose (HEC), hydroxypropylcellulose, hydroxypropylmethyl cellulose (HPMC), and a mixture thereof.

26. The multipurpose contact lens solution of claim 25, wherein the light transmittance at around 280 nm of the cleaned contact lens after at least 15 cycles of soiling and cleaning without rubbing lens is substantially unchanged or decreased by about 20% or less relative to a new (unwom) lens.

27. A kit for cleaning and/or disinfecting contact lenses, comprising a bottle containing a lens care solution, wherein the lens care solution can be dispensed from the bottle into a container where the lens care solution is in contact with one or more contact lenses for a period of time sufficient long to clean and/or disinfect them, wherein the lens care solution has a persistent cleaning-efficacy characterized by substantially maintaining the light transmittance at around 280 nm of a vifilcon contact lens after at least 15 cycles of soiling with a soiling solution and subsequent cleaning with the lens care composition under no-rubbing conditions, wherein the soiling solution is an aqueous solution having a pH of about 7.0 and containing 0.1% lysozyme, 0.4% albumin, 0.5% boric add, 0.6% sodium chloride, 60 ppm Dequest® 2060S (diethylene triamine penta(methylene phosphonic. acid), and 0.03% sodium perborate, wherein the lens care solution comprises at least one surfactant, a polyvinylpyrrolidone (PVP), a cellulose ether, and xylitol, wherein in combination with polyvinylpyrrolidone (PVP), a cellulose ether, and xylitol, the surfactant provides the persistent cleaning-efficacy.
